(19) United States
(12) Patent Application Publication
(10) Pub. No.: US 2004/0046746 A1
(43) Pub. Date: Mar. 11, 2004

(54) Touchscreen tactile feedback system

(76) Inventor: Robert James Monson, St. Paul, MN (US)

Correspondence Address: Carl L. Johnson, Jacobson and Johnson, Suite 285, One West Water Street, St. Paul, MN, 55107-2080, US

(21) Appl. No.: 10/235,162

(22) Filed: Sep. 5, 2002

(51) Int. Cl. G09G 5/00

(52) U.S. Cl. 345/173

(57) ABSTRACT

A tactile feedback system having a mechanical keyboard that mechanically interfaces with a touch screen panel so that when a key is displaced a section of the touch screen panel is activated through key contact thereby providing a tactile response to the operator to enhance the operators confidence that the desired key action has taken place.

### FIELD OF THE INVENTION

This invention relates generally to a tactile feedback system and, more specifically, to a tactile feedback system that includes a keyboard that mechanically interfaces with a touch screen panel.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The concept of touch screen systems and devices having a touch screen panel are well known in the art. Typically, one presses a finger against the touch screen panel to activate a selected region of the panel. While touch screen panels can provide immediate visual indication of contact they do not provide tactile feedback to the user. In order to confirm that an action has taken place on a touch screen panel a user needs to look at the screen to confirm that the correct area has been pressed and that the required action has been performed. Although touch screen panels require visual confirmation of an action they do not provide the tactile feedback needed when critical activities are performed. In order to provide tactile feedback a keyboard can be electrically interfaced with the touch screen system.

The present invention eliminates the need for electrically interfacing a keyboard with a touch screen system by providing a mechanical keyboard having a plurality of keys that when depressed contact the touch screen panel. By coordinating the area of contact of the keys with a selected portion of the touch screen panel one can quickly convert a touch screen system with no tactile feedback to a touch screen system with tactile feedback.

### SUMMARY OF THE INVENTION

A touch screen system with tactile feedback with the system having a mechanical keyboard that mechanically interfaces with a touch screen panel so that when a key is displaced it inherently provides tactile feedback to the user as well as activates a section of the touch screen panel with the tactile feedback enhancing the operators confidence that the key action has occurred.

### BRIEF DESCRIPTION OF THE DRAWINGS

FIG. 1 is a top view of a touch screen with a pivotally attached keyboard in an inoperative position;

FIG. 2 is a side view of the touch screen of FIG. 1;

FIG. 3 is a side view of the touch screen of FIG. 2 with the keyboard rotated into an operative position;

FIG. 4 is a top view of the touch screen of FIG. 1 with the keyboard in the operative position;

FIG. 5 is an isolated sectional view of a portion of the touch screen and one of the keys in the keyboard with the key located in a non-contact condition with the touch screen;

FIG. 5A is an isolated sectional view of a portion of the touch screen of FIG. 5 with and one of the keys in the keyboard located in a contact condition with the touch screen;

FIG. 6 is a an isolated top view of one of the keys of the keyboard having an external marking together a portion of the surrounding resilient key retainer and a portion of the touch screen;

FIG. 7 is a an isolated top view of an alternate embodiment of one of the keys of the keyboard having a transparent viewing surface to allow one to view a portion of the touch screen through the top surface of the key;

FIG. 8 is a side view of the alternate embodiment of FIG. 7 showing the key in the non-contact condition;

FIG. 9 is a top view of a hand-held personal computer with a touch screen having a keyboard pivotally connected in an inoperative condition; and

FIG. 10 is a top view of the personal computer of FIG. 9 with the keyboard pivoted to a condition where the keyboard covers the entire touch screen.

### DESCRIPTION OF THE PREFERRED EMBODIMENT

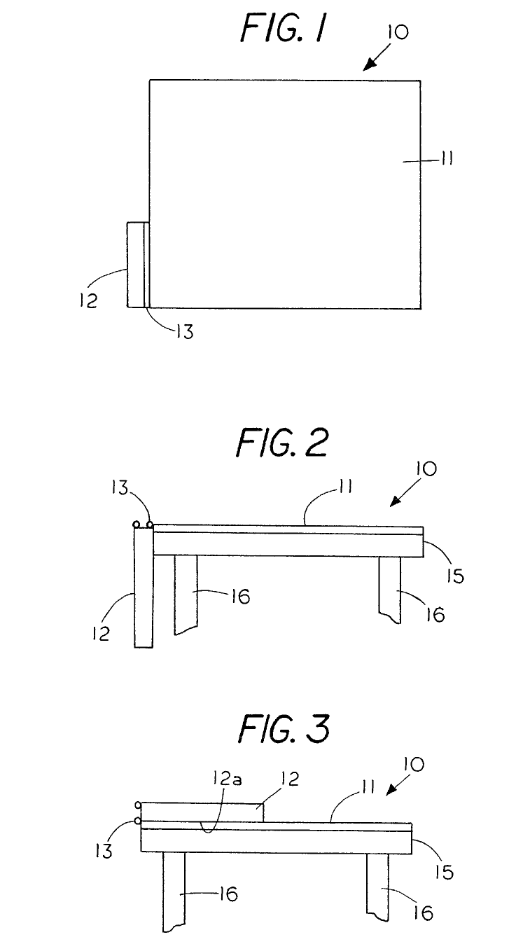

Referring to FIG. 1, reference numeral 10 identifies a touch screen system having a touch screen panel 11 with a mechanical keyboard 12 having a double hinge 13 secured along one side thereof. FIG. 2 shows a side view of the touch screen system 10 with touch screen panel 11 supported by a housing 15 and a set of legs 16. The keyboard 12 is shown in an inoperative position and pivotally supported by a double hinge 13.

Referring to FIG. 3 the keyboard 12 is shown rotated into an operative condition with the backside 12a of keyboard 12 in contact with touch screen panel 11. In this condition the keyboard 12 occupies a fixed portion of the panel 11 and is held in fixed position by hinge 13 and the weight of the keyboard.

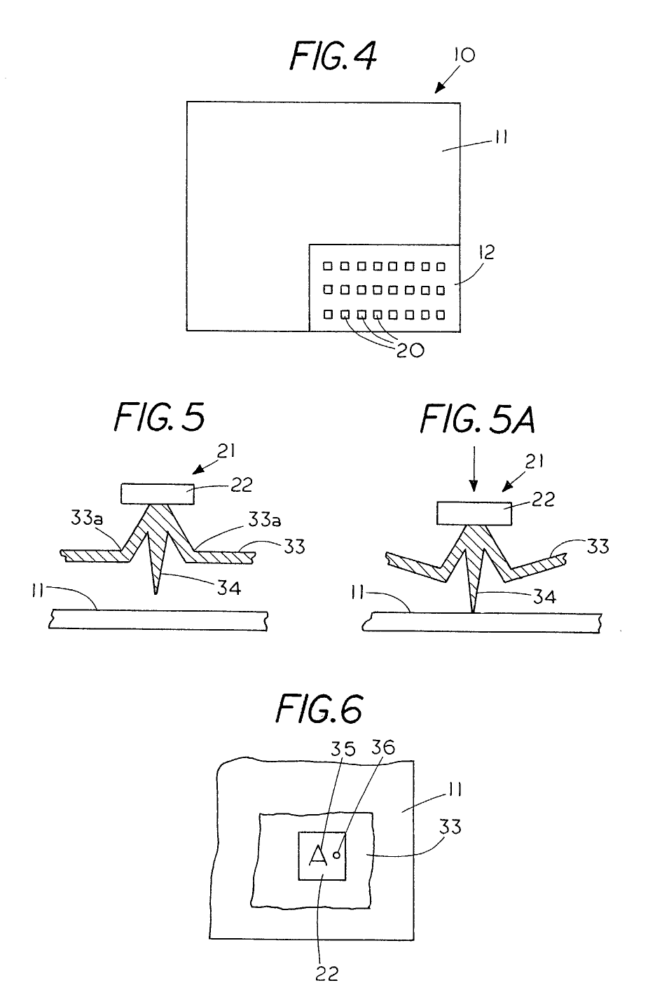

FIG. 4 shows a top view of the touch screen system 10 with the keyboard 12 occupying a portion of touch screen panel 11. Keyboard 12 contains a set of keys 20 that correspond to the familiar conventional typewriter keyboard. One of the advantages of a keyboard is that because of continued practice and the tactile feedback obtained from activating the keys the keyboard users do not have to look at the screen or the keyboard as they type. The displacement of each of the keys as a letter is struck provides sufficient tactile feedback signal to the user to let the user know that key has been activated. In order to let a user know if his or her hands are properly positioned on the keyboard some type of projection or ridge can be placed on selected keys so the user knows his or her hand is properly positioned through feel alone thus eliminated the need to have the person look at the keyboard every time a certain key is struck. A conventional mechanical keyboard has the advantage of letting the user input information without having to look at the keyboard or the screen. In the present invention the tactile feedback inherent in a keyboard is captured by positioning a mechanical keyboard directly on at least a portion of a touch screen panel.

FIG. 5 shows an isolated view of a single key mechanism 21 from keyboard 12 with the single key mechanism 21 comprising a rigid finger pad 22 being supported by resilient member 33 having a contact member 34 protruding therefrom. FIG. 5 shows the key mechanism 21 in the non active condition with contact member 34 spaced from touch screen panel 11.

FIG. 5A shows the key action when a force F is applied to key finger pad 22. Note, the resilient member 33 flexes and bends at areas 33a to allow the contact member 34 to contact the touch screen panel 11. As can be seen from FIG. 5A the displacement of the key finger pad 22 brings the contact member 34 into contact with a selected area on the touch screen panel 11. Thus the touch screen panel 11 is not directly activated by a users finger but is activated by the bringing the contact member 34 into contact with the touch screen panel 11. While the touch screen contact is the same as if a user had placed his or her finger on the touch screen the sensation to the operator has been altered since the operator can now feel the sensation of physical displacement of the key pad 22 as well as the key pad displacement arrested by contact with the touch screen panel 11. Thus the operator receives a tactile feedback signal even though the signal has been applied to a touch screen panel. The sensing of-the displacement of the key pad 22 allows the operator to feel confident the proper input to the touch screen was achieved even though the operator may not be looking at the touch screen panel.

FIG. 6 shows an isolated top view of a key 21 with the touch panel 11 extending laterally below the key pad 22. The resilient member 33 which can be a rubber diaphragm or some type of spring to provides sufficient resistance to displacement of key pad 22 so as to create a pressure sensation in the user's finger thereby providing the necessary tactile feedback to let the user know that the key has been properly activated. Resilient member 33 also allows the key pad 22 to return to non-active condition so as to be ready for further input.

In the embodiment shown the key pad 22 includes, for example, a reference letter 35, to let an operator know which letter will appear on the screen when a key is struck. In addition, key pad 22 includes a slight protuberance or ridge 36 while the surrounding key pads do not. This allows a user to locate his or her hand in the proper position on the keyboard without having to look at the keyboard keys.

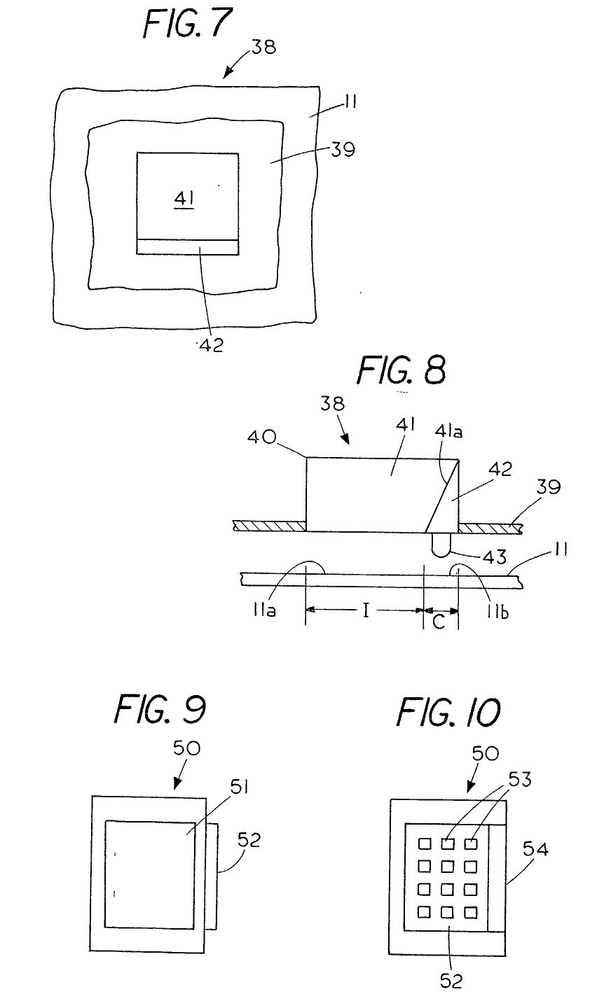

FIG. 7 shows an alternate embodiment of an isolated top view of a key mechanism 38 that enables a user to view an image on the touch screen panel. This feature allows a user a quick visually confirmation if each of the keys when struck produces the proper response on the touch screen panel. The isolated key mechanism 38 comprises a key pad 40 that is supported by a resilient member 39. Key pad 40 comprises two parts, a transparent viewing section 41 and a non-transparent section 42.

FIG. 8 shows a side view of the isolated key mechanism 38 of FIG. 7 showing that key pad 40 comprises a transparent section 41 that allows a user to look through the key pad 40 and observe the image area 11a on touch screen 11. Located as part of key pad 40 is a second portion that can be opaque but which carries a contact member 43 for physically contacting the touch panel 11 in the region denoted by reference numeral 11b. That is a downward force on key pad 40 brings contact member 43 into contact with touch screen 11 at region 11b causing an image to appear at image area 11a which can be viewed through the transparent viewing window 41 located as part of key pad 40. This feature not only allows a user to check to see if pressing the key pad 40 brings the proper response but it also could allow one to change the key response in the system and still allow a user to use the keyboard. For example, the system that generates the touch screen could provide letters in a different language so that the keyboard operation was not limited to only English responses.

In the embodiment of FIGS. 1-4 the keyboard is shown in conjunction with a touch screen panel wherein the keyboard only occupies a portion of the touch screen. One of the features of the present invention is that it can be used with hand held computers having touch screens. FIG. 9 shows a top view of a hand held computer 50 having a touch screen 51 and a keyboard 52 hinged to computer 50 with keyboard 52 shown in the inoperative condition. In this condition the user may be reviewing information contained on the screen.

FIG. 10 shows the keyboard 52 pivoted to cover the entire touch screen by pivoting the keyboard about hinge 54. In this condition the keys 53 cover the entire touch panel. This type of device is particularly useful for someone taking on-the-go inventory since the user can use one hand to input information to the computer 50 without having to look at the screen. The feedback from displacing the keys provides sufficient feedback to let the user know the proper entry is made. Should the user decide to check on other matters the keyboard 52 is rotated to an out-of-the way condition and the hand held computer 51 can be used as a conventional hand held computer. In the embodiment shown the key pad may be programmed with a conventional keyboard or may contain only numerals for entering inventory data.

While the keyboard is shown hingedly connected to the hand held computer or the touch screen system other methods of attachment are usable with the invention. For example, a pin and hole arrangement where a pin on the touch screen system is aligned with a reference hole in the keyboard.

I claim:

1. A tactile feedback system for mechanical interfacing with a touch screen work station comprising:
a keyboard,
an attachment member for positioning said keyboard on a touch screen panel; and
a plurality of movable keys resiliently mounted in said keyboard, each of said movable keys having a member for contacting a touch screen region so that when one of said plurality of movable keys is displaced the displacement thereof generates a touch screen signal thereby providing both a tactile user sensation and a touch screen response.

2. The invention of claim 1 wherein the attachment member comprises a spring.

3. The invention of claim 1 wherein the plurality of movable keys are resiliently mounted in said keyboard.

4. The invention of claim 1 wherein the keyboard includes at least 26 keys.

5. The invention of claim 1 wherein the keyboard occupies only a portion of a touch screen.

6. The invention of claim 1 wherein the keyboard occupies an entire touch screen.

7. The invention of claim 1 wherein the keyboard is maintained in a fixed position relative to the touch screen panel.

8. The invention of claim 1 wherein each of the keys include a transparent section for viewing an image on the touch screen panel therethrough.

9. The invention of claim 1 wherein at least one of the keys in the keyboard includes a reference location protuberance.

10. A touch screen device;
a touch screen panel located on said touch screen device;
a keyboard, said keyboard having a plurality of displaceable keys thereon each of said displaceable member having a contact member thereon;
an attachment member, said attachment member securing said keyboard in either a non-operative position with respect to said touch screen panel or an operative position with respect to said touch screen panel whereby the keyboard is mechanically interfaced with the touch screen panel so that displacement of a key of said plurality of keys directly contacts a specific region of said touch screen thereby providing tactile feedback to an operator.

11. The touch screen device of claim 10 wherein the plurality of displaceable keys includes a finger sensitive reference ridge.

12. The touch screen device of claim 11 wherein the plurality of displaceable keys includes a transparent section for viewing an image located on the touch screen panel.

13. The touch screen device of claim 12 wherein the keyboard covers only a portion of the touch screen panel to allow one to view an image on the uncovered section of the touch screen panel.

14. The touch screen device of claim 13 wherein the atachment member comprises a spring.

15. The method of providing tactile feed back to a touch screen system comprising the steps of:
positioning a touch screen panel in a ready to use condition;
positioning a keyboard having a mechanical key mechanism in a spaced condition from the touch screen panel; and
transmitting information to the touch screen panel by displacing a selected key on the keyboard to thereby bring a member into physical contact with the touch screen panel.

16. The method of claim 15 including the step of making the selected key of a see-through material to permit a viewer to view an image therethrough.

17. The method of claim 15 including the step of pivotally securing the keyboard to the touch screen system to bring the keyboard into a mechanical interface condition with the touch screen panel.

18. The method of claim 15 including the step of positioning the keyboard over only a portion of the touch screen panel.

19. The method of claim 15 including the step of positioning the keyboard over the entire touch screen panel.

20. A keyboard:
a plurality of keys on said keyboard, each of said keys having a key pad with a top striking surface and a lower contact member, each of said key pads characterized by having a see-through material therein to allow a user to view an image located below the key pad by viewing the object through the key pad.
